(19) United States
(12) Patent Application Publication
(10) Pub. No.: US 2019/0389128 A1
(43) Pub. Date: Dec. 26, 2019

(54) ROTOR BLADE

(71) Applicant: NewSouth Innovations Pty Limited, Sydney - New South Wales (AU)

(72) Inventors: Con Doolan, New South Wales (AU); Chaoyang Jiang, Leichhardt (AU)

(21) Appl. No.: 16/209,101

(22) Filed: Dec. 4, 2018

(30) Foreign Application Priority Data
Jun. 22, 2018 (AU) 2018902243

(51) Int. Cl. B29C 64/153; B64C 21/02

(52) U.S. Cl. CPC B29C 64/153; F03D 1/0675; B64C 21/02

(57) ABSTRACT

A method of manufacturing a portion of an aerofoil, the portion having an outer surface, the outer surface comprising a porous region, the method comprising using an additive manufacturing technique to manufacture the portion.

### CROSS-REFERENCE TO RELATED APPLICATION

This application claims the benefit of priority under 35 U.S.C. § 119(b) to Australian Application Serial No. 2018902243, filed Jun. 22, 2018.

### TECHNICAL FIELD

Embodiments relate to a rotor blade and attachments for rotor blades.

### BACKGROUND

It has been known to use small perforations in a surface covering a cavity to reduce noise attributed to airflow over the surface. See, e.g., “Potential of microperforated panel absorber”, Dah-You Maa, The Journal of the Acoustical Society of America 104, 2861 (1998).

### SUMMARY

An embodiment relates to a method of manufacturing a portion of an aerofoil, the portion having an outer surface, the outer surface comprising a porous region, the method comprising using an additive manufacturing technique to manufacture the portion.

The flexibility of additive manufacturing allows the use of complex and optimised porous structures that can give the designer more control of acoustic edge scattering as well as the interaction of the aerofoil's boundary layer turbulence with porosity. This method may also minimise the aerodynamic drag penalty associated with noise control devices.

The additive manufacturing technique may comprise sequential deposition, e.g. 3D printing using polymers and sintering.

The portion may be adapted to be used at a trailing edge of the aerofoil.

The portion may be a sleeve for fitting over an end of the aerofoil.

The porous region may comprise a plurality of similarly dimensioned pores, the pores having an aspect ratio defined relative to the average depth and diameter of the pores. The pores may have the same diameter, but vary in height. Alternatively, the pores may have the same diameter and height across the porous region.

A percentage of a surface area of the portion of the porous region comprising pores (i.e. the porosity of the region) may be less than 8%. It has been found, for certain embodiments, below a porosity of 8%, a peak in acoustic absorption may occur at lower frequencies. For example, between 5 and 6 kHz.

A percentage of a surface area of the portion of the porous region comprising pores may be greater than or equal to 8%. It has been found, for certain embodiments, above a porosity of 8%, peak absorption may occur at the higher frequencies. Therefore, the porosity may be selected according to the performance characteristics required.

A further embodiment extends to a portion of an aerofoil, the portion having an outer surface with a porous region, wherein the porous region comprises a plurality of similarly spaced pores, the pores having an aspect ratio defined relative to the average depth and diameter of the pores.

The portion may be adapted to be used at a trailing edge of the aerofoil. The portion may be affixed directly to an outer surface of the aerofoil. In this case, ‘directly affixed’ may mean without a cavity between the portion and the surface of the aerofoil.

The porous region comprises a plurality of similarly dimensioned pores, the pores having an aspect ratio defined relative to the average depth and diameter of the pores. The pores may have the same dimension and/or the same height.

A percentage of a surface area of the portion of the porous region comprising pores is less than 8%.

A percentage of a surface area of the portion of the porous region comprising pores is greater than or equal to 8%.

The portion may comprise a sleeve for fitting over an end of the aerofoil.

The portion may be incorporated into a trailing edge of an aerofoil.

An embodiment further extends to an aerofoil comprising a portion as herein described.

The portion may be incorporated into the trailing edge of the aerofoil.

### BRIEF DESCRIPTION OF THE DRAWINGS

Embodiments are herein described, with reference to the accompanying drawings in which:

FIGS. 1A and 1B illustrate an acoustic test piece;

FIG. 2 is a further illustration of acoustic test pieces;

FIG. 3 illustrates a rotor blade sleeve according to an embodiment;

FIG. 4 is a schematic illustration of an aerofoil and a portion thereof;

FIGS. 5A and 5B are graphs showing acoustic absorption spectra for various embodiments;

FIG. 6 is a graph of peak acoustic absorption with aspect ratio;

FIG. 7 is a graph of porosity, absorption and frequency;

FIG. 8 illustrates sound produced by a rotor blade incorporating an embodiment compared to a rotor blade according to the prior art; and

FIGS. 9A to 9F are various comparisons of noise generated by a rotor blade incorporating an embodiment of the invention versus rotor blades according to the prior art.

FIGS. 10A to 10F are additional comparisons of noise generated by a rotor blade incorporating an embodiment of the invention versus rotor blades according to the prior art.

FIGS. 11A to 11F are additional comparisons of noise generated by a rotor blade incorporating an embodiment of the invention versus rotor blades according to the prior art.

FIGS. 12A to 12F are additional comparisons of noise generated by a rotor blade incorporating an embodiment of the invention versus rotor blades according to the prior art.

FIGS. 13A to 13D are additional comparisons of noise generated by a rotor blade incorporating an embodiment of the invention versus rotor blades according to the prior art.

### DETAILED DESCRIPTION

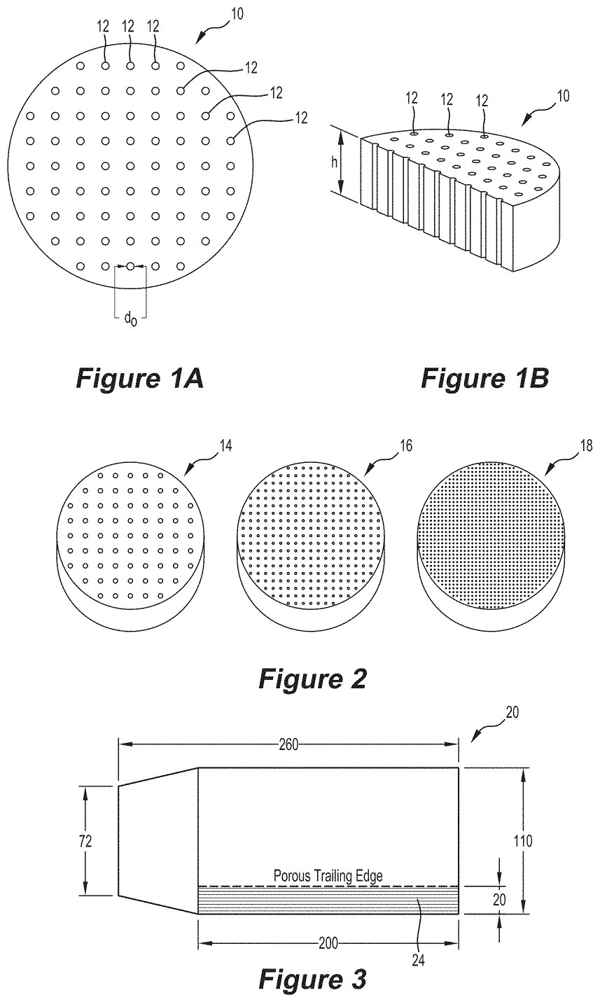

FIG. 1A illustrates an acoustic test piece 10 and shows the kind of porous material used with embodiments of the invention. FIG. 1B shows a cross section through the test piece 10. The test piece is formed with a plurality of pores 12. Each pore has a diameter d₀ and a height h. In the test pieces illustrated, the pore extends through the entire thickness of the test piece 10, but in alternate arrangement, the pore extends through a portion of the thickness of the piece 10. FIG. 2 is a further illustration of acoustic test pieces 14, 16 and 18 each having the same general porous structure as the test piece 10 of FIG. 1. The pores have an aspect ratio which is defined as a ratio of the diameter to the height (d₀/h). The number of pores per unit surface area is the porosity, expressed as a percentage.

FIG. 3 illustrates a sleeve 20 according to an embodiment. The sleeve 20 has the dimensions as illustrated (in millimetres). The sleeve 20 is open at one end 22 for fitting over the end of a rotor blade. The sleeve 20 is further formed with a porous region 24 formed with pores as shown in FIGS. 1 and 2. In this embodiment, the entire sleeve 20 was manufactured using 3D printing with a polymer.

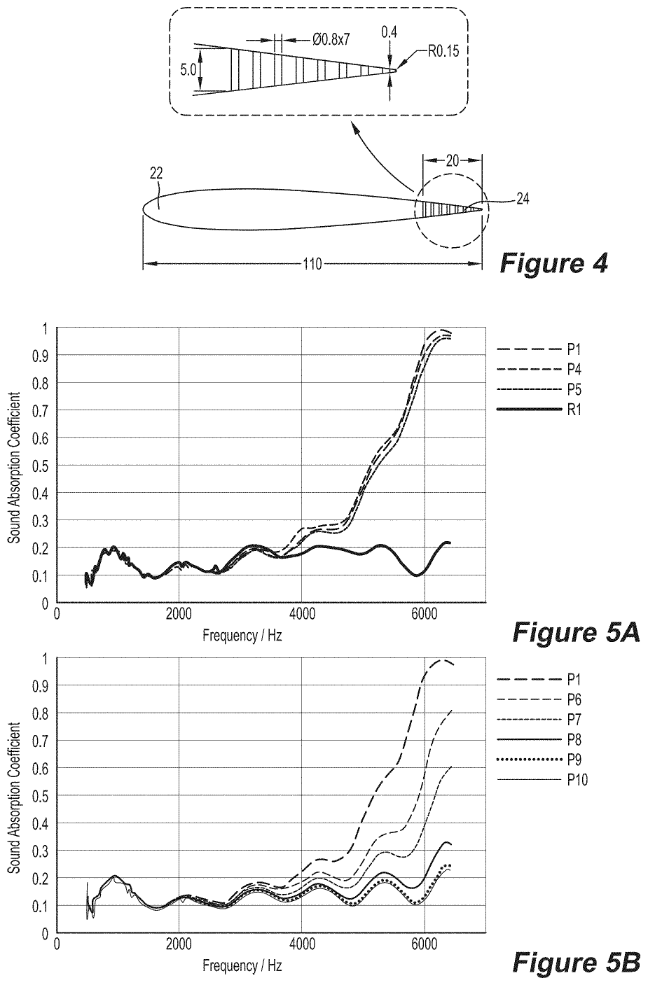

A cross section through the sleeve 20 is shown in FIG. 4 with the porous region 24 shown in the exploded section. The pores of the porous region 24 have a diameter of 0.8 mm. The aspect ratio (γ) varies between 0.16 and 2. The porous region 24 has a porosity of 10.5%.

The following porous structures may be used (in addition to variations on these):

TABLE 1

| | Specimen | | | | | | | | | | | | |
|---|---|---|---|---|---|---|---|---|---|---|---|---|---|
| | P1 | P2 | P3 | P4 | P5 | P6 | P7 | P8 | P9 | P10 | R1 | R2 | R3 |
| d₀ (mm) | 1 | 1 | 1 | 0.8 | 0.6 | 1 | 1 | 1 | 1 | 1 | 0 | 0 | N/A |
| Porosity (%) | 11.5 | 8.2 | 5.34 | 11.1 | 11.5 | 11.5 | 11.5 | 11.5 | 11.5 | 11.5 | 0 | 0 | 92~94 |
| h (mm) | 10 | 10 | 10 | 10 | 10 | 9 | 8 | 7 | 6 | 5 | 10 | 5 | 10 |
| Γ | 0.1 | 0.1 | 0.1 | 0.08 | 0.06 | 0.11 | 0.13 | 0.14 | 0.17 | 0.2 | N/A | N/A | N/A |

The inventors have found that sound absorption is insensitive to pore diameter if porosity and thickness are kept constant. FIG. 5A illustrates the sound absorption of samples P1, P4 and P5 relative to reference sample R1 (having no pores).

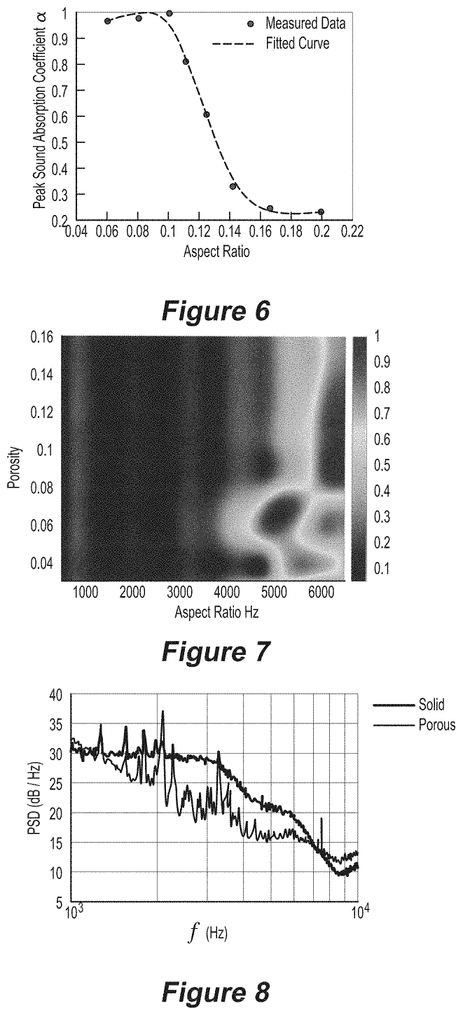

FIG. 5B shows the effect of aspect ratio, γ=d₀/h. Here, a comparison is made between γ=0.1 (P1), 0.11 (P6), 0.13 (P7), 0.14 (P8), 0.17 (P9) and 0.20 (P10). It has been shown that, as the aspect ratio increases, absorption decreases. This effect is more clearly shown in FIG. 6, where the peak absorption is plotted against pore aspect ratio. A rapid reduction in peak absorption was observed once aspect ratio exceeds a value of about γ=0.1.

All measured absorption spectra are combined in FIG. 7 to provide a summary of the relationship between porosity, absorption and frequency. Above a porosity of 8% (0.08 in the Figure), peak absorption occurs at the highest frequencies. Below a porosity of 8%, a peak in absorption occurs between 5 and 6 kHz.

It can be inferred from these results that acoustic absorption is influenced by the pore geometry. Additive manufacturing is an efficient method to produce many samples that can be used to build empirical models of acoustic performance. These empirical models can be used as a guide to develop porous trailing edge designs.

Two sets of acoustic measurements were performed. The first used 70 mm chord, solid aluminium rotor blades without the blade extensions at a rotor speed (C))=600 RPM. The second were obtained with the additively manufactured blade sleeves of the type shown in FIG. 3 with porous trailing edges attached to each rotor blade for a rotational speed of Ω=600 RPM. The solid aluminium blades are referred to as solid blades and the blade extensions with porous trailing edges as referred to as porous blades.

FIG. 8 shows the power spectral density of the acoustic signal obtained at the array centre between 1 kHz-10 kHz, for the case where the rotational speed was set to Ω=600 RPM and the pitch angle is set to θ=0°. The use of the porous blade extensions results in significant noise reduction between 1 kHz and 7 kHz.

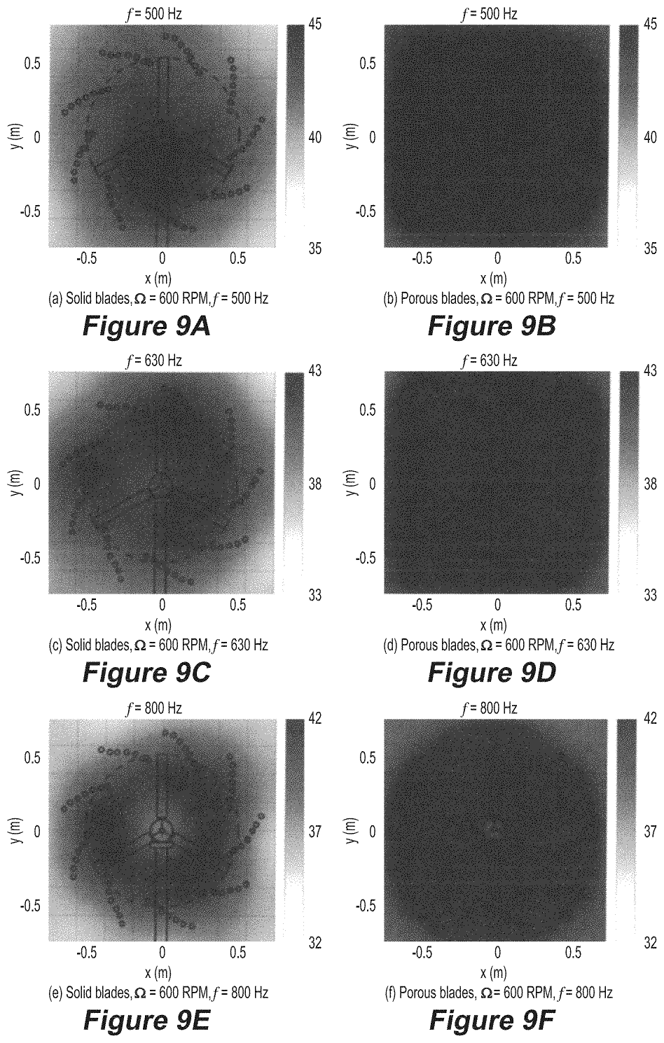

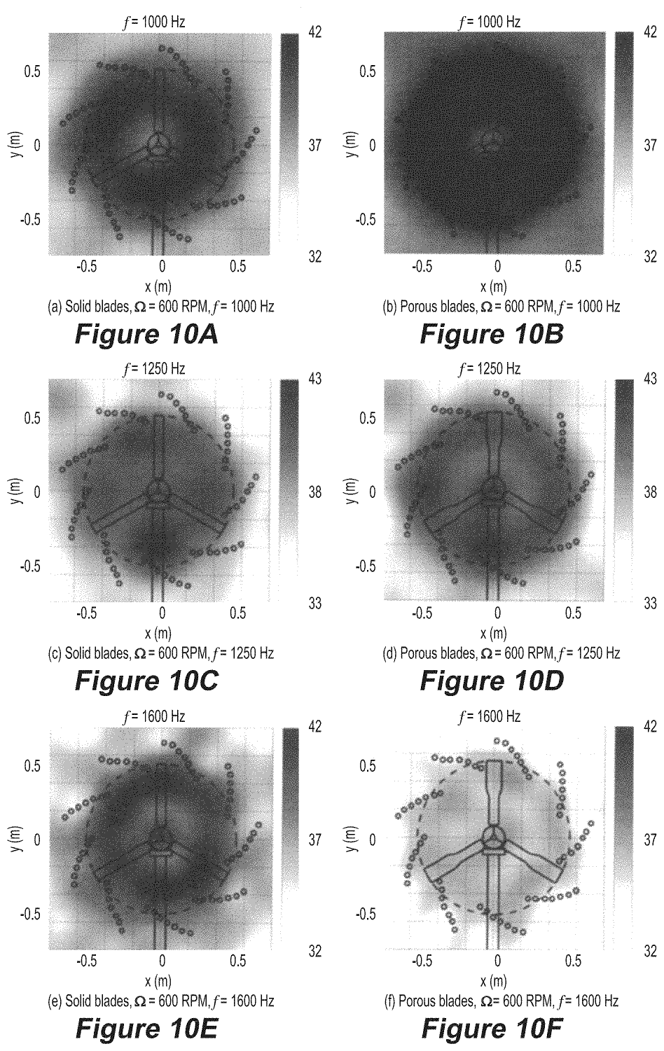

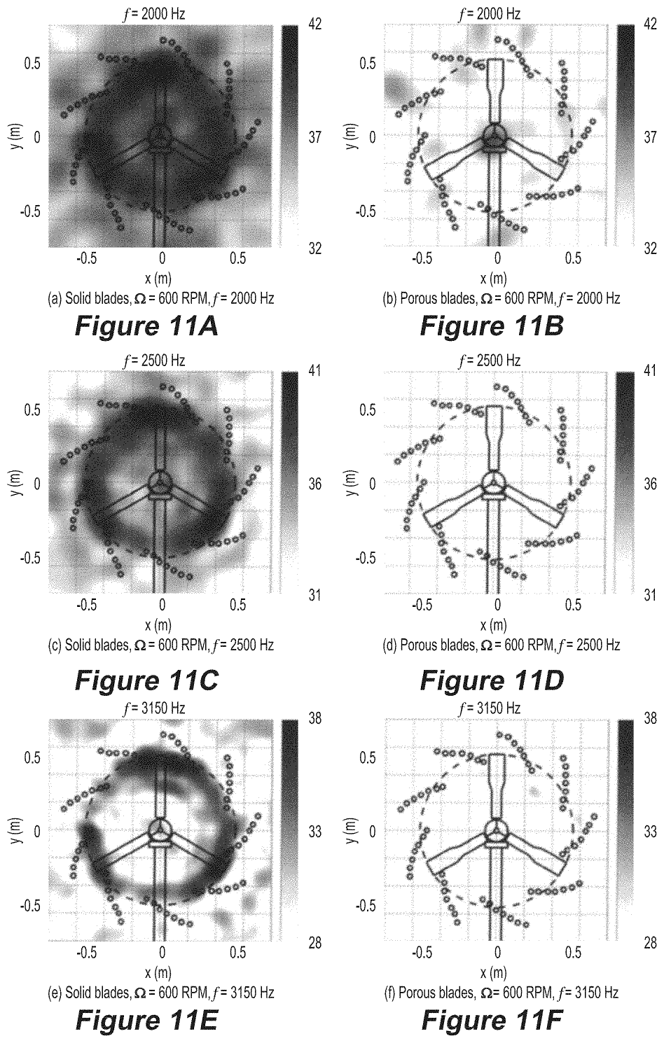

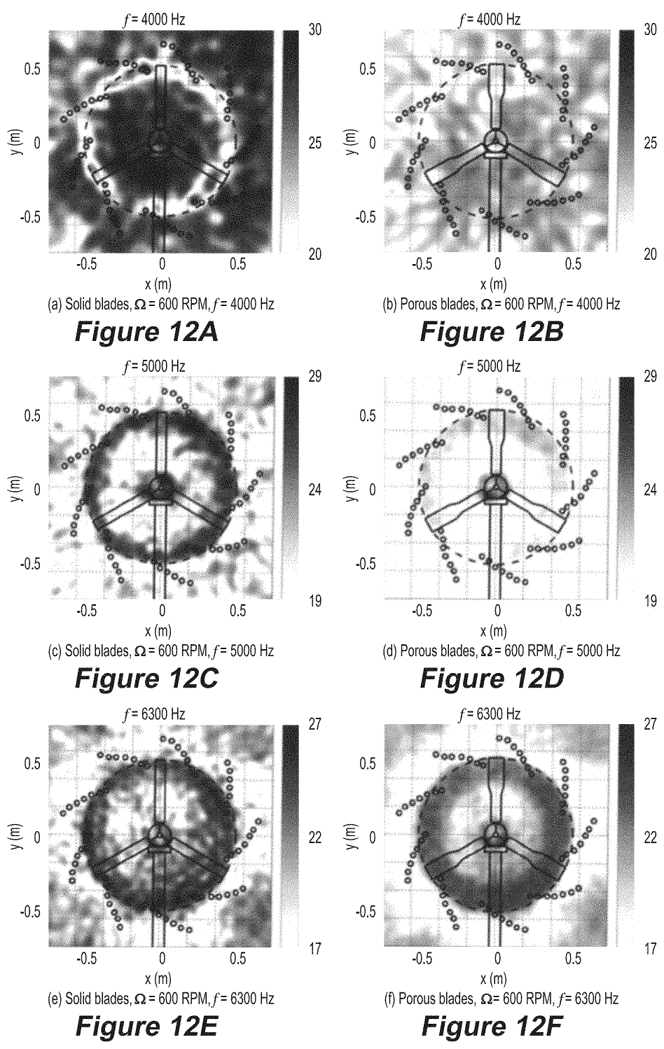

FIGS. 9A to 9F illustrate experimental conventional beamforming (CBF) maps for rigid and porous blades, where the rotational speed (Ω)=600 RPM, f=500; 630 and 800 Hz. FIGS. 10A to 10F illustrate CBF maps for rigid and porous blades, Ω=600 RPM, f=1,000; 1,250 and 1,600 Hz. FIGS. 11A to 11F illustrate CBF maps for rigid and porous blades, Ω=600 RPM, f=2000; 2,500 and 3,150 Hz. FIGS. 12A to 12F illustrate CBF maps for rigid and porous blades, Ω=600 RPM, f=4,000; 5,000 and 6,300 Hz.

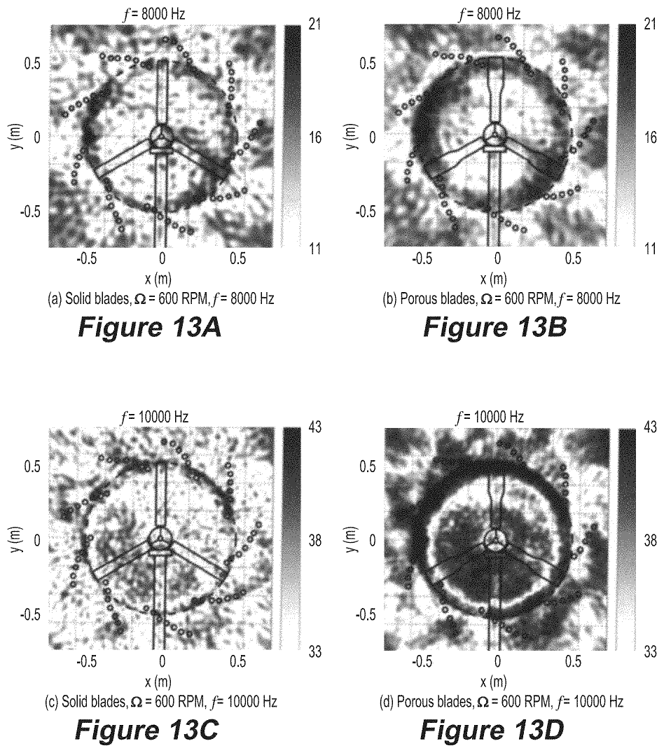

FIGS. 13A to 13F illustrate CBF maps for rigid and porous blades, Ω=600 RPM, f=8,000 and 10,000 Hz.

As the array centre is aligned with the rotational centre of the rotor rig, the acoustic field received by the array is a concentric ring, whose centre is coincident with the centre of the rotor. Generally, the acoustic source strength is high at the outer part of the blades, due to the high velocity of the blades towards the tip. There is also some mechanical noise identified at the centre of the rotor rig, which is due to a slip-ring device.

Below the 1250 Hz centre band, the porous blades produce more noise than the solid ones, which is reflected in the more intense and larger source regions in the beamformer output plots (FIGS. 10A to 10F). Centre frequencies 1,250 Hz and above show significantly less source strength in the outer radial regions for the porous blades, compared with the solid ones. Lower source strengths are observed up to the 6,300 Hz centre frequency. At higher frequencies, more intense acoustic radiation occurs from the rotor blades, compared with the solid blades.

Embodiments comprising a sleeve for a rotor blade have been described, but it is to be realised that other arrangements are possible too. For example, the porous region may be manufactured as an overlay for the rotor blade. Alternatively, the rotor blade may be manufactured with a porous region, e.g. by using an additive manufacturing technique to manufacture the entire blade.

Furthermore, embodiments have been described as applying to rotor blades, but other aerofoils may equally be used such as wings. Furthermore, embodiments may be applied to any surface moving through gas such as air for which it is desired to reduce noise. Blades with embodiments may be flat or curved in profile. Certain embodiments may apply to reduce noise from technology such as (but limited to) wind turbines, unmanned aerial vehicle (UAV) propellers and cooling fans.

It is to be understood that, if any prior art publication is referred to herein, such reference does not constitute an admission that the publication forms a part of the common general knowledge in the art, in Australia or any other country.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments.

What is claimed is:

1. A method of manufacturing a portion of an aerofoil, the portion having an outer surface, the outer surface comprising a porous region, the method comprising using an additive manufacturing technique to manufacture the portion.

2. The method of claim 1 wherein the additive manufacturing technique comprises sequential deposition.

3. The method of claim 1, wherein the additive manufacturing technique is sintering.

4. The method of claim 1, wherein the additive manufacturing technique comprises 3D printing using polymers and sintering.

5. The method of claim 1, wherein the portion is adapted to be used at a trailing edge of the aerofoil.

6. The method of claim 1, wherein the portion is a sleeve for fitting over an end of the aerofoil.

7. The method of claim 1, wherein the porous region comprises a plurality of similarly dimensioned pores, the pores having an aspect ratio defined relative to the average depth and diameter of the pores.

8. The method of claim 1, wherein a percentage of a surface area of the portion of the porous region comprising pores is less than 8%.

9. The method of claim 1, wherein a percentage of a surface area of the portion of the porous region comprising pores is greater than or equal to 8%.

10. A portion of an aerofoil, the portion comprising an outer surface with a porous region, the porous region comprising a plurality of similarly spaced pores, the pores having an aspect ratio defined relative to the average depth and diameter of the pores.

11. The portion of claim 10, adapted to be used at a trailing edge of the aerofoil.

12. The portion of claim 10, wherein the porous region comprises a plurality of similarly dimensioned pores, the pores having an aspect ratio defined relative to the average depth and diameter of the pores.

13. The portion of claim 10, wherein the aspect ratio is greater than 0.1.

14. The portion of claim 10, wherein a percentage of a surface area of the portion of the porous region comprising pores is less than 8%.

15. The portion of claim 10, wherein a percentage of a surface area of the portion of the porous region comprising pores is greater than or equal to 8%.

16. The portion of claim 10, comprising a sleeve for fitting over an end of the aerofoil.

17. The portion of claim 10, incorporated into a trailing edge of an aerofoil.

18. An aerofoil comprising a portion according to claim 10.

19. The aerofoil of claim 18, wherein the portion is incorporated into the trailing edge of the aerofoil.
